(19) United States
(12) Patent Application Publication
(10) Pub. No.: US 2012/0134071 A1
(43) Pub. Date: May 31, 2012

(54) ELECTROCHEMICAL DOUBLE-LAYER CAPACITOR USING NANOTUBE ELECTRODE STRUCTURES

(75) Inventors: Donald R. Sadoway, Cambridge, MA (US); John G. Kassakian, Newton, MA (US); Joel E. Schindall, Arlington, MA (US); Riccardo Signorelli, Cambridge, MA (US)

(73) Assignee: Massachusetts Institute of Technology, Cambridge, MA (US)

(21) Appl. No.: 12/956,131

(22) Filed: Nov. 30, 2010

(51) Int. Cl. H01G 9/155; B82Y 99/00

(52) U.S. Cl. 361/502; 977/742; 977/932

(57) ABSTRACT

Methods and apparatus for an electrochemical double-layer capacitor using nanotube structures. An electrochemical double-layer capacitor includes a first carbon nanotube-based electrode and a second carbon nanotube-based electrode mixed with an electrolyte, the carbon nanotubes comprising multiwall carbon nanotubes (MWNT) fabricated on one of a plurality of substrates using chemical vapor deposition (CVD), and a separator disposed between the first carbon nanotube-based electrode and the second carbon nanotube-based electrode.

### BACKGROUND OF THE INVENTION

The invention generally relates to electrochemical double-layer capacitors, and more specifically to an electrochemical double-layer capacitor using nanotube structures.

An electric double-layer capacitor, also known as a “supercapacitor,” “supercondenser,” “pseudocapacitor,” “electrochemical double layer capacitor (EDLC),” or “ultracapacitor,” is an electrochemical capacitor that has an unusually high energy density when compared to common capacitors, typically on the order of thousands of times greater than a high capacity electrolytic capacitor.

EDLCs have a variety of commercial applications, notably in “energy smoothing” and momentary-load devices. They have applications as energy-storage devices used in vehicles, and for smaller applications like home solar systems where extremely fast charging is a valuable feature.

### SUMMARY OF THE INVENTION

The present invention discloses an electrical double layer capacitor having electrodes constructed of vertically aligned carbon nanotubes (VCNTs) grown on a conducting substrate. The energy density of a carbon nanotube-based electrical double layer capacitor is many times that of commercial activated carbon-based electrical double layer capacitors.

In general, in one aspect, the invention features an electrochemical double-layer capacitor including a first carbon nanotube-based electrode and a second carbon nanotube-based electrode mixed with an electrolyte, the carbon nanotubes including multiwall carbon nanotubes (MWNT) fabricated on one of a plurality of substrates using chemical vapor deposition (CVD), and a separator disposed between the first carbon nanotube-based electrode and the second carbon nanotube-based electrode.

In another aspect, the invention features an electrochemical double-layer capacitor including a first vertically aligned carbon nanotube-based electrode and a second vertically aligned carbon nanotube-based electrode mixed with an electrolyte, the vertically aligned carbon nanotubes including multiwall carbon nanotubes (MWNT) fabricated on one of a plurality of substrates using chemical vapor deposition (CVD), and a separator disposed between the first vertically aligned carbon nanotube-based electrode and the second vertically aligned carbon nanotube-based electrode.

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIG. 1 is a block diagram.

FIG. 2 is an exemplary scanning electron micrograph.

FIG. 3 is an exemplary graph.

FIG. 4 is an exemplary scanning electron micrograph.

FIG. 5 is a exemplary graph.

FIG. 6 is a table.

FIG. 7 is a table.

FIG. 8 is a table.

Like reference numbers and designations in the various drawings indicate like elements.

### DETAILED DESCRIPTION

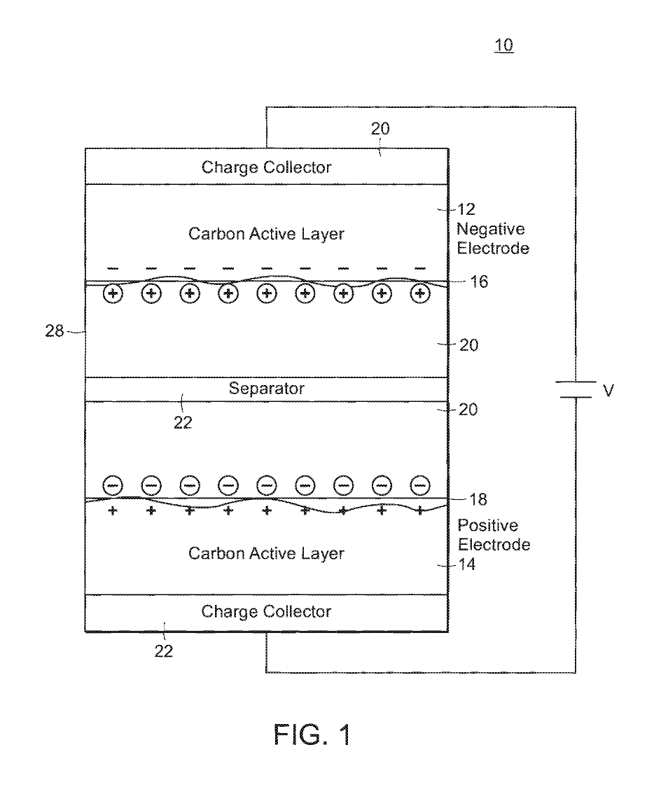

As shown in FIG. 1, an exemplary carbon nanotube-based electrochemical double-layer capacitor (EDLC) 10 in accordance with this invention includes two carbon nanotube-based electrodes 12, 14, each with a double layer of charge at an electrolyte interface. In general, carbon nanotubes (CNTs) are graphite layers rolled into the form of a hollow cylinder whose diameter is in an order of nanometer scale. The electrodes 12, 14 are the two electrically conducting parts of the EDLC 10.

The exemplary carbon nanotube-based EDLC 10 includes charge collectors 16, 18, respectively, an electrolyte 20 and a separator 22. In general, the electrolyte 20 is a chemical compound (salt, acid or base) that disassociates into electrically charged ions when dissolved in a solvent. The resulting electrolytic solution is an ionic conductor of electricity. In general, the separator 22 is a thin structural material (usually a sheet) used to separate the electrodes 12, 14, of a divided electrochemical cell into two or more compartments.

In general, the basic measures of EDLC performance are the electrode surface area, the electrode area-specific differential capacitance, the electrode volumetric capacitance, the frequency behavior of the impedance, the shape of the cyclic voltammetry trajectory, and the ESR which is reflected in the power density of the device.

The electrode surface area—the total nonplanar surface area of the carbon—is measured using a technique known as the BET method, and the result is known as the BET surface area with units of m²/g. The measurement is made by relating the weight of a monolayer of gas adsorbed on the accessible surface of the electrode to the surface area of a uniform monolayer of the gas.

The electrode area-specific capacitance in units of μF/cm², commonly known as the differential capacitance or intrinsic capacitance, C_{D}, is the incremental capacitance (dQ/dV) of 1 cm² of the BET measured surface area of the carbon nanotube. It is a function of both the measurement frequency and bias voltage. The frequency dependence arises because of the different transit times of ions penetrating the different pore sizes in the carbon. The voltage dependence is due to the nonlinear relationship between the charge in the Helmholtz layer and the potential between the solid electrode and the bulk of the electrolyte, and for low electrolyte molarities is most pronounced at a potential far from the potential of zero charge. For high electrolyte molarities, at higher voltages, the incrementation of surface charge by the presence of a charge diffusion layer causes the measured C_{D} to become approximately constant with voltage.

The gravimetric capacitance of the electrode is an often cited metric. Assuming that the entire BET surface area is accessible to the ionic charge, the gravimetric specific capacitance can be approximately calculated by the product of C_{D} and the BET surface area. However, as with C_{D}, it does not provide a measure from which the performance of an EDLC could be inferred, since these metrics do not reflect electrode planar surface area.

The volumetric specific capacitance, however, provides a useful comparative measure of EDLC electrode performance. It is the capacitance of 1 cm³ of electrode volume. Because it reflects the density of pores, or how tightly packed a nanotube structure is, as well as the area specific capacitance, it enables a relative measure of the physical size of a device with a specific rating.

Impedance data is generally presented as the traditional Nyquist diagram of the small-signal impedance around a bias. In general, a Nyquist diagram or plot is used for assessing the stability of a system with feedback. It is represented by a graph in polar coordinates in which the gain and phase of a frequency response are plotted. The plot of these phasor quantities shows the phase as the angle and the magnitude as the distance from the origin. This plot combines the two types of Bode plots—magnitude and phase—on a single graph, with frequency as a parameter along the curve.

Cyclic voltammetry is an electrochemical analysis technique that plots the electrochemical cell current against its voltage at a fixed magnitude of rate of change of voltage (the scan rate). The waveform of the scan voltage vs. time is triangular. The technique is most often used in the investigation of Faradaic reactions, that is, reactions that involve mass transfer. In theory, an EDLC does not involve a Faradaic reaction. In practice, however, there are Faradaic components to the EDLC behavior and cyclic voltammetry can provide insight to these processes. A pure capacitor of constant capacitance has a rectangular cyclic voltammetry plot. A nonzero ESR will generate exponential transitions to a constant current at the voltage where the scan changes sign. A noninfinite shunt resistance will generate an increasing current with increasing voltage, i.e., the plot will become trapezoidal. At voltages high enough to initiate a redox reaction the current increases in an exponential fashion. The shape of the voltammetry plot manifests the complexity of the electrochemical processes at play in the EDLC.

The ESR of an EDLC cell is a function of frequency. At very low frequencies, the ESR is fairly constant, but at frequencies above the knee the ESR decreases. The power density of an EDLC is determined from the IR drop seen at the terminals when a step of current is applied. The power is then calculated for a load matched to this resistance. When in the context of experimental electrode materials, this parameter is generally expressed as the gravimetric power density kW/kg of electrode material, e.g., the weight of the carbon nanotubes. As a practical matter, the power density provides a comparative measure of the pulsed power capability of EDLCs.

While commercial devices are characterized by specific capacitance, energy density and power density normalized by packaged weight and size, experimental results of carbon nanotube based electrode research are not presented in a canonical form. Presented results can be normalized by current collector (planar electrode) surface area, electrode (total nanotube) surface area, carbon weight, carbon plus current collector weight, carbon plus current collector plus separator plus electrode weight or volume, and so forth. Experiments are done using small electrode samples (e.g., 1 cm²) tested in various electrolytes using custom designed test cells. As described above, an EDLC includes two electrodes with a porous separator between them. Each electrode represents a double-layer capacitor of value C. The packaged EDLC thus has a capacitance C/2. When interpreting experimental data it is necessary to know whether the data is for a single electrode or a two electrode cell. One must be careful in making performance comparisons among different published results. In what follows we have either normalized results to a common reference where possible, or indicated the measurement conditions. The power density (kW/kg) is frequently specified for experimental electrodes. This parameter is meaningless in early experimental results as it is a function of only the voltage and ESR. The ESR in experimental cells is not indicative of the ESR of a properly packaged device with practical electrodes. We focus on the volumetric and gravimetric energy densities.

Multiwall carbon nanotubes (MWNT) on a variety of substrates using chemical vapor deposition (CVD) are fabricated for use in the electrodes 12, 14 of EDLC 10. In a preferred embodiment, low-pressure chemical vapor deposition (LPCVD) is used. The fabrication process uses a gas mixture of acetylene, argon, and hydrogen, and an iron catalyst deposited on the substrate using electron beam vaporization. Fabricated electrodes are 1 cm² and tested in an experimental cell using 1.4 M acetonitrile. The fabrications demonstrate the growth of long CNTs on a conducting substrate, determine the wetting properties of the electrolyte, identify process parameters that control CNT density and wall numbers, and provide measurements indicative of the electrical properties of the electrodes 12, 14.

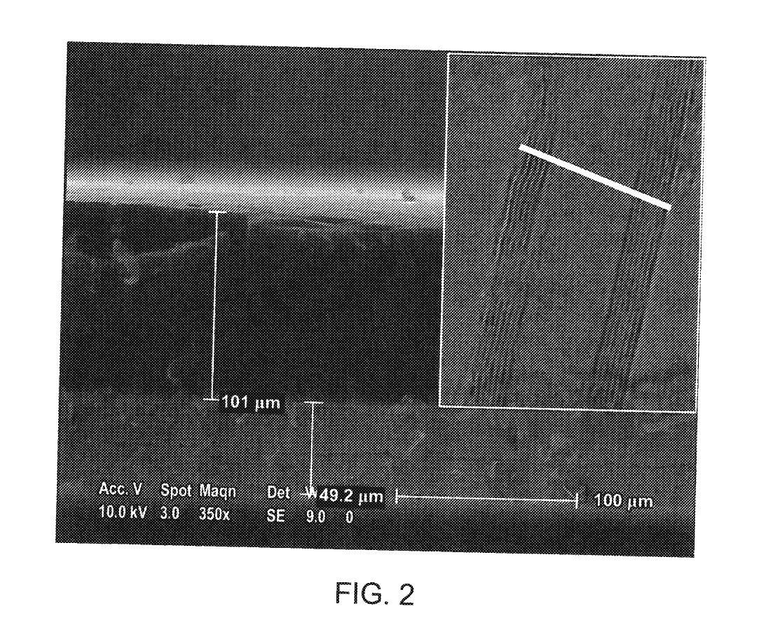

FIG. 2 is an electron micrograph of CNTs grown on a tungsten substrate. The inset shows a single seven-wall nanotube. On average, the “as-grown” CNTs have three walls and have been grown as long as 300 μm.

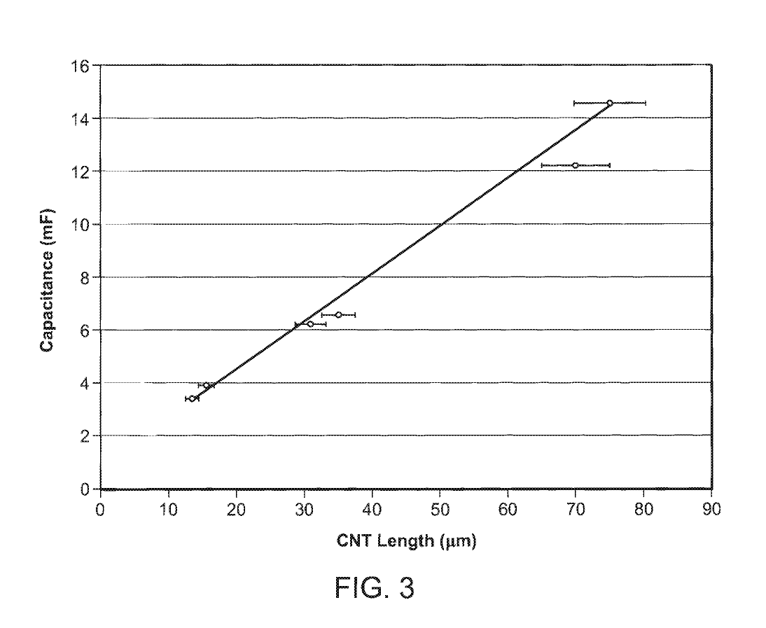

FIG. 3 is a graph of the experimentally measured electrode capacitance as a function of nanotube length. The approximately linear relationship supports the assumption that the electrolyte is completely wetting the carbon layer.

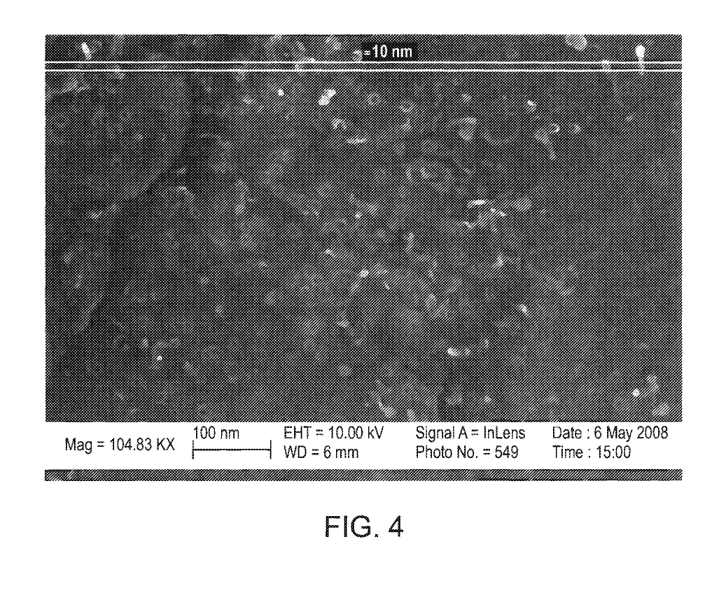

The density of nanotubes is determined by removing the carbon layer and observing the residual tube “footprints” on the substrate surface. Using either atomic force microscopy (AFM) or scanning electron microscopy (SEM), the footprints are counted within a measured surface area. FIG. 4 is one such photograph showing the footprints as tiny circular divots. The maximum measured density achieved to date is 4×10¹¹/cm².

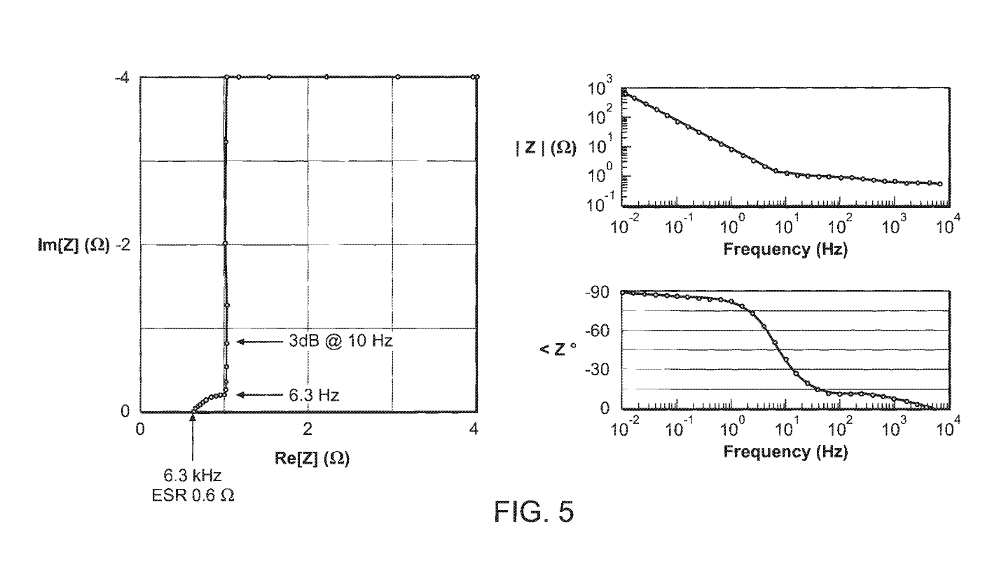

Knowing the density, average number of walls, diameter, and length of the tubes, and the density of carbon, the weight of the nanotube layer can be computed. Confirmation is obtained by weighing the electrode before and after nanotube growth. The resulting differential (carbon area specific) capacitance, C_{D}, was determined to be 10 μF/cm². This relatively low value is due to the lack of either thermal or acid after treatment of the nanotubes. Nyquist and Bode graphs for one electrode are shown in FIG. 5. These plots show a capacitance of about 16 mF for the 1 cm² sample, implying a two electrode cell capacitance of 8 mF.

The energy density currently achievable with commercial ultracapacitors is enhanced using an electrode structure based on vertically aligned carbon nanotubes (VCNT) as the active layer. The model presented here shows that energy densities up to 21 Wh/kg and 22 Wh/l are obtainable at a voltage of 2.7 V for a packaged DLC cell using the VCNT-based electrodes. These values are approximately four times those obtained today by the commercial activated carbon-based DLCs. In the event that a higher molarity electrolyte is practical, the CNT-based DLC can function up to 3.5 V, providing energy densities up to 35 Wh/kg and 37 Wh/l.

The morphology of the nanotube film we fabricated is composed of nanotubes having an average diameter of 3 nm and multiple walls for each nanotube with an average spacing between nanotube centers of 5 nm, which corresponds to a nanotube density of 1×10¹¹/cm² to 4×10¹²/cm². The average length of the nanotube active layer is 75-300 μm. A 15 μm thick aluminum film is used as the charge collector (having a density ρ_{A1} of 2.7 g/cc). Tungsten can also be used. The accessible surface area of a multiple wall nanotube, for example, is assumed to be 250-600 m²/g, which is one-fourth that of a single wall nanotube, and its differential capacitance is assumed to be 50 μF/cm² (after proper treatment). The targeted operating voltage for the proposed cell (V_{M}) is 2.7 V. Although the absence of a contaminating binder and activation process would permit an operating voltage of 3.5 V, the high electrolyte molarity required to support this voltage may have other consequences. Here, 2.7 V and a molarity (M) of 2.0 are assumed.

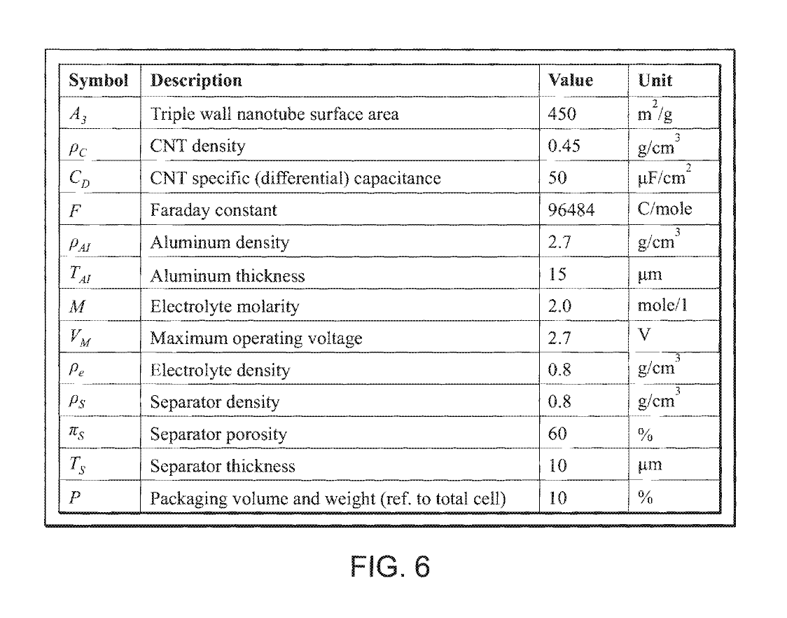

The electrolyte is triethylmethylammonium tetrafluoroborate, generally referred to as TEMA BF4, in acetonitrile, which has a density of 0.8 g/cm³. Common DLC separator paper is usable. Its thickness is 10 μm, its density is 0.8 g/cm³, and its porosity is 60% voids over the total paper volume. FIG. 6 includes a table that lists the values of the electrode and DLC cell parameters upon which our energy density modeling and calculations are based.

The gravimetric (C_{W}) and volumetric (C_{V}) specific capacitances of a single VCNT electrode active layer can be calculated from the CNT active layer differential capacitance, surface area, and density

$$\begin{matrix}{C}_{W} = {C}_{D} \cdot {A}_{3} \\ = ( 50 µ F ) \cdot ( 450 g ) \cdot ( 104 ) \\ = 225 F \text{/} g\end{matrix}$$

$${C}_{V} = {C}_{D} \cdot {A}_{3} \cdot {ρ}_{C} = 103 F \text{/} {cm}^{3} .$$

The energy density of two VCNT electrode active layers in a DLC cell configuration is calculated under the assumption that the specific capacitances are constant with respect to voltage. This assumption leads to conservative estimates since the DLC capacitance typically exhibits a slight increase with voltage

E_{W}=1/8C_{W}·V_{M}²·1/3.6=57 Wh/kg

E_{V}=1/8C_{V}·V_{M}²·1/3.6=26 Wh/l.

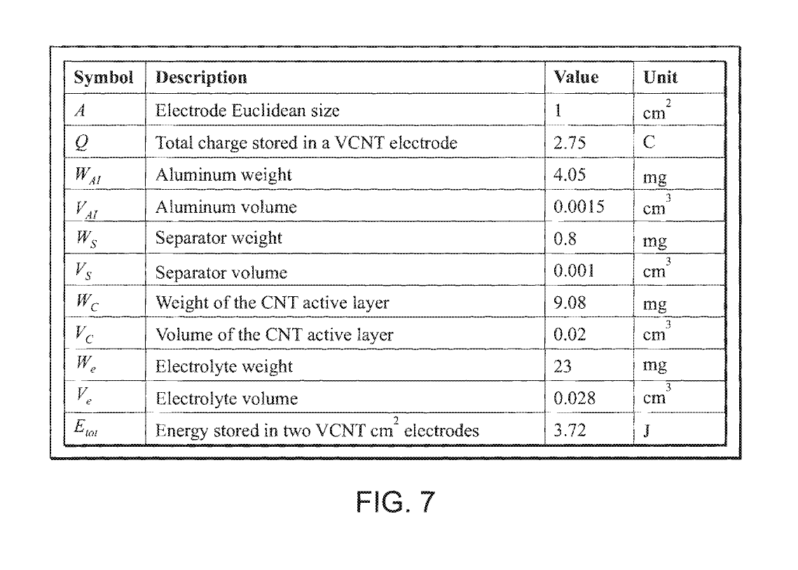

These energy densities improvement are due to the assumption of an organic electrolyte allowing for higher voltage, and a higher C_{D}. Although electrode performance is useful for comparing different active layer structures and materials, to evaluate the viability of our VCNT electrode technology we estimate the achievable energy density of a packaged cell. The parameters used to make this estimation for a DLC cell using two 1 cm² VCNT electrodes are summarized in a table in FIG. 7, along with the resulting total energy stored in the cell at V_{M}. The charge, Q, in this table is the ionic charge required for one electrode at a voltage of 1.35 V (half the cell voltage) and a capacitance of 2.04 F (C_{W}W_{C}). The energy densities of a cell comprised of two VCNT active layers and aluminum charge collectors, separator, and electrolyte are given by

E′_{W}=E_{TOT}/[2·(W_{AL}+W_{C})+W_{S}+Wₑ=23.0 Wh/kg

E′_{V}=24.2 Wh/l.

The weights of each CNT active layer and of the necessary electrolyte are

W_{C}=ρ_{C}·V_{C}=9.08 mg

W_{E}=(2Q·ρe)/(M·F)=23 mg.

The electrolyte weight, We, is calculated based on the assumption that twice the minimum required ion density, Q, is necessary to maintain electrolyte conductivity. Assuming a weight and volume of the packaging equivalent to 10% of the total cell weight and volume (electrodes, electrolyte and separator), the overall volumetric and gravimetric energy densities are estimated using the following equations; these assumptions are realistic when aluminum is used for the cell package

E″_{W}=E′_{W}×0.9=21 Wh/kg

E″_{V}=E′_{V}×0.9=22 Wh/l.

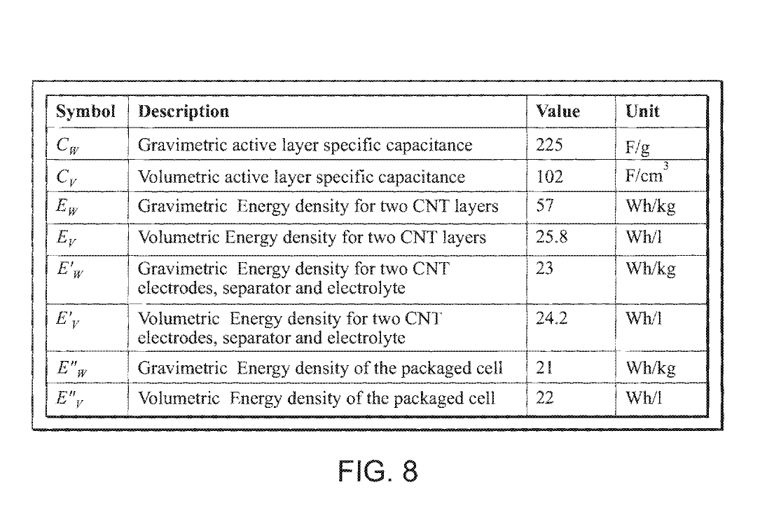

The calculated values in table in FIG. 8 are based on an assumed maximum working voltage of 2.7 V. However, this limitation is due to electrolyte degradation in conventional activated carbon DLCs resulting from contamination during the activation process and from the binder used to attach the carbon to the current collector. The purity of CNTs avoids this contamination, resulting in the ability to operate the device at a working voltage approaching 3.5 V. Keeping volume fixed, the higher voltage would require a higher molarity electrolyte. Under these conditions the energy densities are increased to about 35 Wh/kg and 37 Wh/l.

It is to be understood that the foregoing description is intended to illustrate and not to limit the scope of the invention, which is defined by the scope of the appended claims. Other embodiments are within the scope of the following claims.

What is claimed is:

1. An electrochemical double-layer capacitor comprising:
a first carbon nanotube-based electrode and a second carbon nanotube-based electrode mixed with an electrolyte, the carbon nanotubes comprising multiwall carbon nanotubes (MWNT) fabricated on one of a plurality of substrates using chemical vapor deposition (CVD); and
a separator disposed between the first carbon nanotube-based electrode and the second carbon nanotube-based electrode.

2. The electrochemical double-layer capacitor of claim 1 wherein the chemical vapor deposition is low-pressure chemical vapor deposition (LPCVD).

3. The electrochemical double-layer capacitor of claim 1 wherein the multiwall carbon nanotubes are vertically aligned carbon nanotubes (VCNT).

4. The electrochemical double-layer capacitor of claim 1 wherein the multiwall call carbon nanotubes have an average diameter of 3 nanometers (nm) and multiple walls for each nanotube with an average spacing between nanotube centers of 5 nm.

5. The electrochemical double-layer capacitor of claim 4 wherein an accessible surface area of the multiple walls for each nanotube is approximately 250-600 m²/g.

6. The electrochemical double-layer capacitor of claim 4 wherein a length of a nanotube active layer is 75-300 μm.

7. The electrochemical double-layer capacitor of claim 1 wherein the multiwall call carbon nanotubes have a density of 1×10¹¹/cm² to 4×10¹²/cm².

8. The electrochemical double-layer capacitor of claim 1 wherein the substrate is tungsten.

9. The electrochemical double-layer capacitor of claim 8 wherein the substrate has an average thickness of 10-100 μm.

10. An electrochemical double-layer capacitor comprising:
a first vertically aligned carbon nanotube-based electrode and a second vertically aligned carbon nanotube-based electrode mixed with an electrolyte, the vertically aligned carbon nanotubes comprising multiwall carbon nanotubes (MWNT) fabricated on one of a plurality of substrates using chemical vapor deposition (CVD); and
a separator disposed between the first vertically aligned carbon nanotube-based electrode and the second vertically aligned carbon nanotube-based electrode.

11. The electrochemical double-layer capacitor of claim 10 wherein the CVD is low-pressure chemical vapor deposition (LPCVD).

12. The electrochemical double-layer capacitor of claim 10 wherein the vertically aligned carbon nanotube-based electrodes have an average diameter of 3 nanometers (nm) and multiple walls for each nanotube with an average spacing between nanotube centers of 5-20 nm.

13. The electrochemical double-layer capacitor of claim 12 wherein an accessible surface area of the multiple walls for each nanotube is 250-600 m²/g.

14. The electrochemical double-layer capacitor of claim 12 wherein a length of a nanotube active layer is 75-300 μm.

15. The electrochemical double-layer capacitor of claim 10 wherein the vertically aligned carbon nanotubes have a density of 1×10¹¹/cm² to 4×10¹²/cm².

16. The electrochemical double-layer capacitor of claim 10 wherein the substrate is tungsten.

17. The electrochemical double-layer capacitor of claim 16 wherein the substrate has a thickness of 10-100 μm.
